(19) United States
(12) Patent Application Publication
(10) Pub. No.: US 2007/0044668 A1
(43) Pub. Date: Mar. 1, 2007

(54) METHOD FOR FORMING STRAIGHT EDGE WATTLE AND STRAIGHT EDGE WATTLE FORMED THEREBY

(76) Inventors: Ernest Montano, Merced, CA (US); Sonny Montano, Merced, CA (US)

Correspondence Address: VIERRA MAGEN MARCUS & DENIRO LLP, 575 MARKET STREET SUITE 2500, SAN FRANCISCO, CA, 94105, US

(21) Appl. No.: 11/466,443

(22) Filed: Aug. 22, 2006

Related U.S. Application Data
(60) Provisional application No. 60/710,434, filed on Aug. 23, 2005.

(51) Int. Cl. A23N 4/04

(52) U.S. Cl. 99/537

(57) ABSTRACT

A method of forming a straight edge wattle is disclosed, together with a straight edge wattle formed thereby. A wattle may be formed with one or more straight edges, and may have a square cross-section. Wattles according to the present invention may be formed from a conventional hay bale by sawing the hay bale into wattles. Sawing the hay into wattles, instead of first pulverizing the hay and then forcing it into the netting, allows the wattles to have a predetermined cross-sectional shape.

### PRIORITY DATA

The present application claims priority to U.S. Provisional Patent Application Serial No. 60/710,434 filed on Aug. 23, 2005.

### BACKGROUND

1. Field of the Invention

The present invention relates to a method for forming straight edge wattle and straight edge wattle formed thereby.

2. Description of Related Art

Wattles are tubes of straw encased within a plastic netting or burlap which are affixed to a slope or other landscape to provide erosion control, sediment control and storm water runoff control. A typical wattle may be 8-9 inches diameter and about 25 feet long, though the diameter and length may vary. Wattles help to stabilize slopes by slowing, spreading and filtering overland water flow. Wattles also capture sediment, enabling seeds to settle and germinate, while preventing sediment from polluting lakes and waterways. Wattles are also used on flat ground projects such as constriction sites.

Conventional wattles are formed from straw bales which is pulverized and/or shredded, and then fed into a hopper. From the hopper, the pulverized straw is forced by an auger or other means through a chute in the hopper into a length of netting to form a wattle of desired length. Of significance, the pulverized straw has no inherent shape to it. The netting is generally cylindrical, and the finished wattle is cylindrical. As such, the wattle will roll or move unless properly staked, and, of the circular cross-sectional diameter, a small portion of the wattle actually lies in contact with the ground.

### SUMMARY

The present invention relates in general to a method of forming a straight edge wattle, and a straight edge wattle formed thereby. In embodiments, a wattle is formed with one or more straight edges, and may have a square cross-section. Wattles according to the present invention may be formed from a conventional hay bale by sawing the hay bales into wattles. Sawing the hay into wattles, instead of first pulverizing the hay and then forcing it into the netting, allows the wattles to have a predetermined cross-sectional shape.

### DESCRIPTION OF THE DRAWINGS

FIG. 1 is a top view of a wattle according to an embodiment of the present invention.

FIG. 2 is a side view of a wattle according to an embodiment of the present invention.

FIG. 3 is an end view of a wattle according to an embodiment of the present invention.

FIG. 4 is an end view of a wattle according to an alternative embodiment of the present invention.

FIGS. 5, 6 and 11-20 are illustrations of an apparatus for forming the wattles according to embodiments of the present invention.

FIGS. 7-10 show the different sizes and shapes into which a hay bale may be sawed to form wattles according to embodiments of the present invention.

FIGS. 21-23 are illustrations of wattles formed according to embodiments of the present invention.

### DETAILED DESCRIPTION

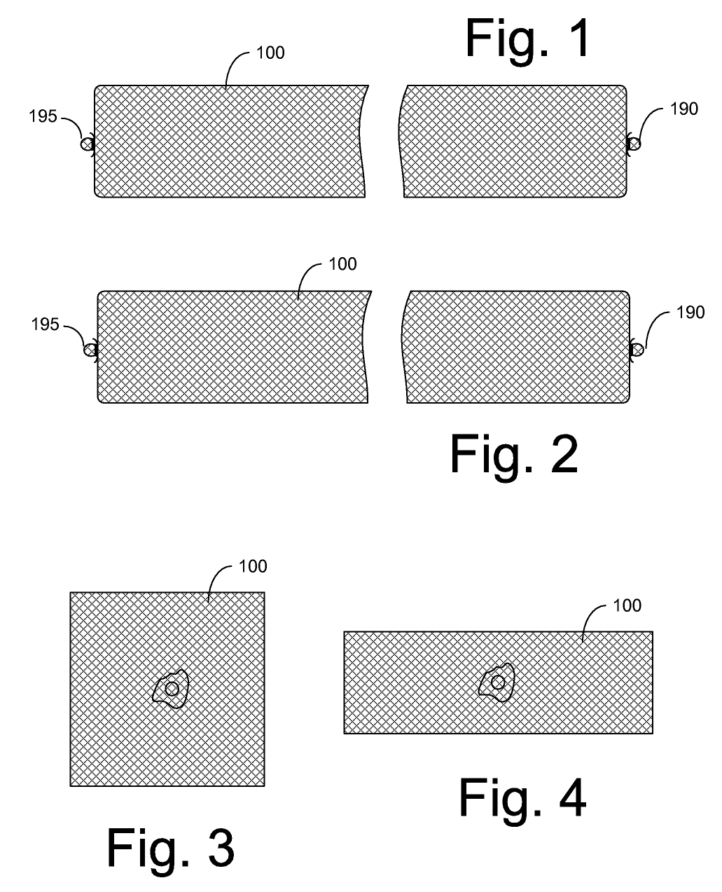

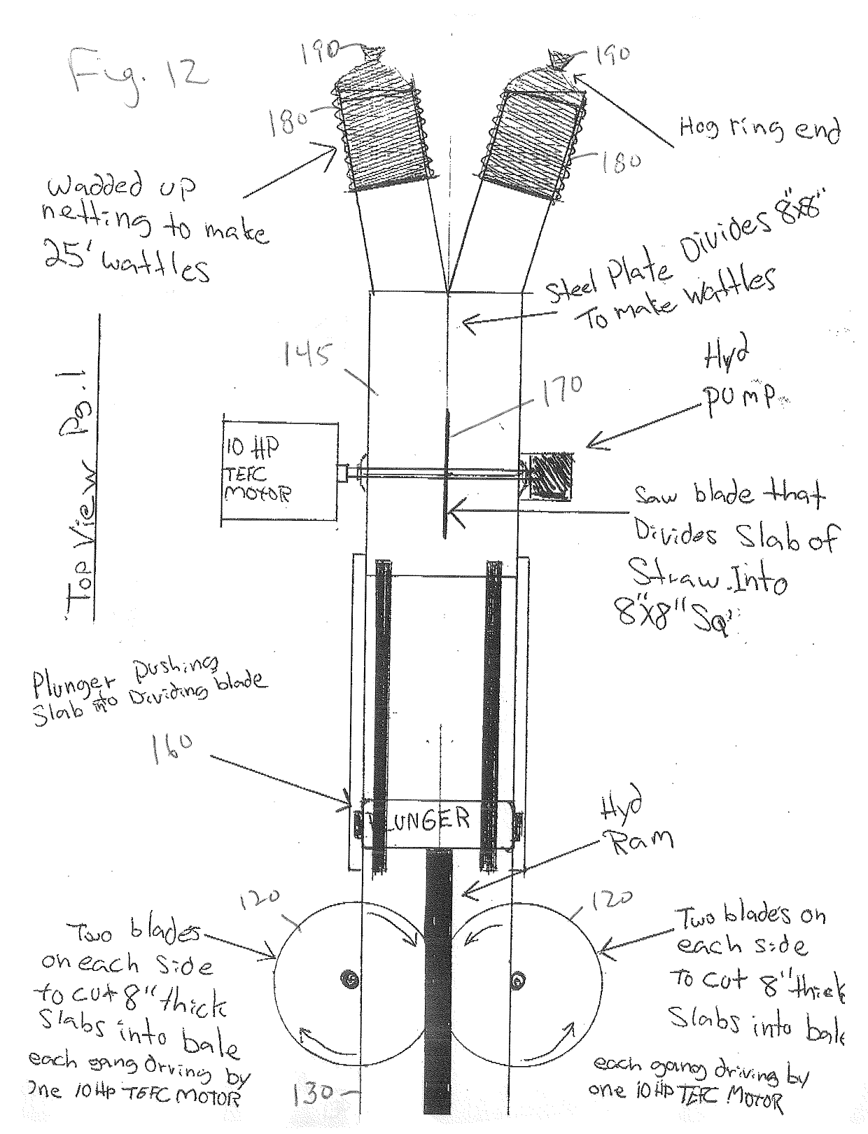

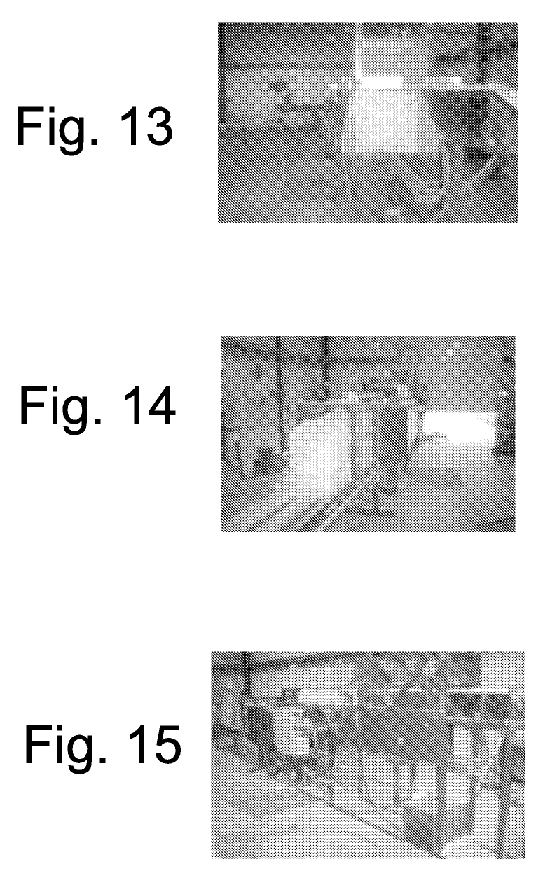

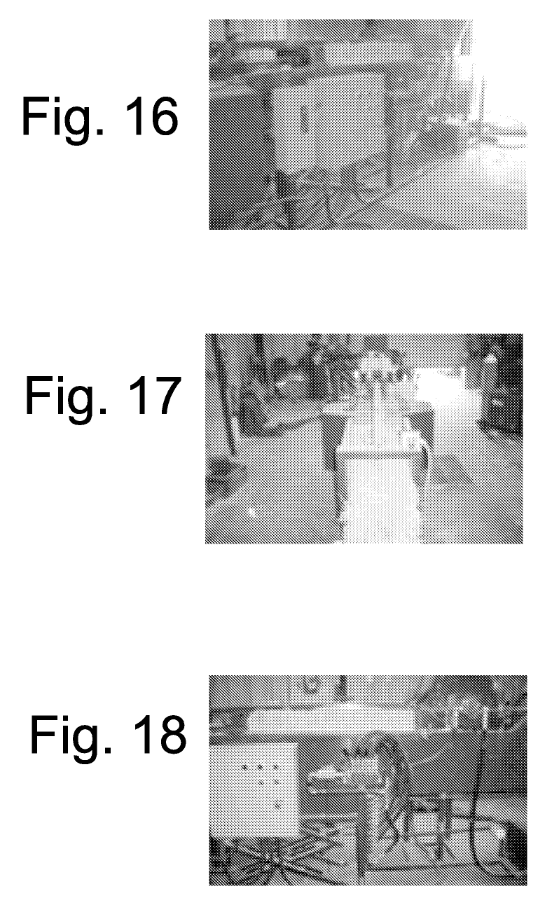

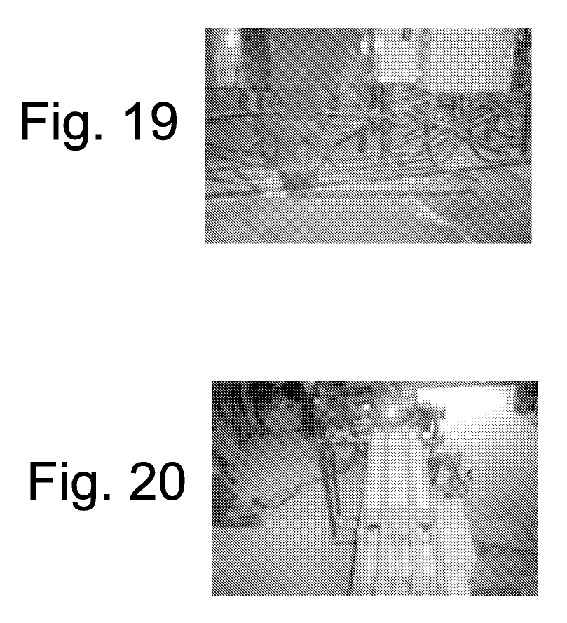

Embodiments of the invention will now be described with reference to FIGS. 1 through 23, which relate to a method of forming a straight edge wattle, and a straight edge wattle formed thereby. A wattle according to the present invention is a structure generally formed of hay or other plant material bundled within netting. The wattle may be used in various best management practice situations, for example top soil maintenance, storm water pollution control on all construction projects, fire burn rehabilitation, timber harvest erosion control, revegetation projects, streambank restoration, mine and land reclamation, vineyard management, ski slope maintenance, and a variety of other embodiments where erosion and sediment protection is required.

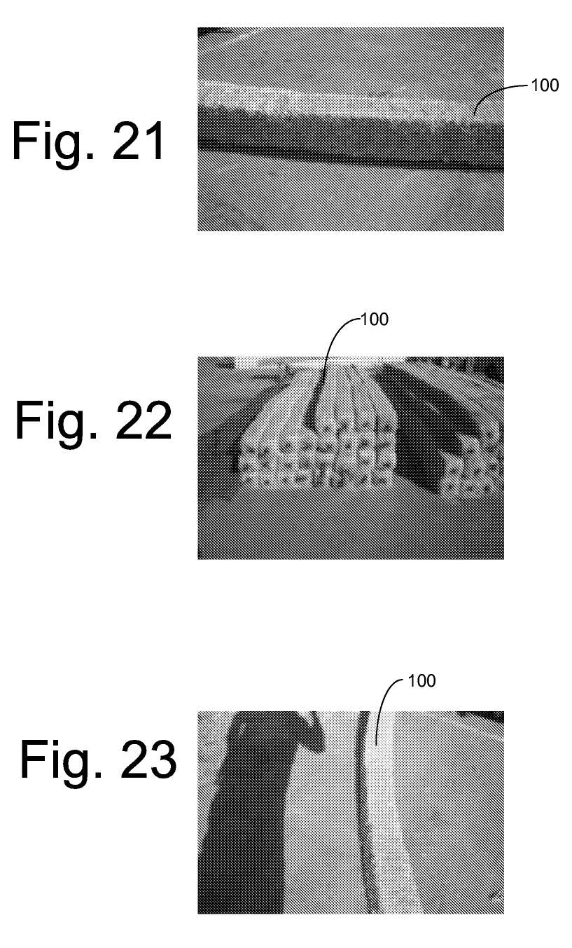

According to embodiments of the present invention, the wattle 100 is formed with one or more straight edges. In embodiments, the wattle may have a square cross section, as shown in the top and side views of FIGS. 1 and 2, the end view of FIG. 3 and perspective views of FIGS. 21 through 23. The wattle may have a rectangular cross-section as shown in the end view of FIG. 4. The wattle may have other polygonal cross-sectional shapes in alternative embodiments. In embodiments, the wattle may have one or more straight edges, and one or more rounded edges in cross-section. The wattle may be formed to any length perpendicular to the cross-section of the wattle.

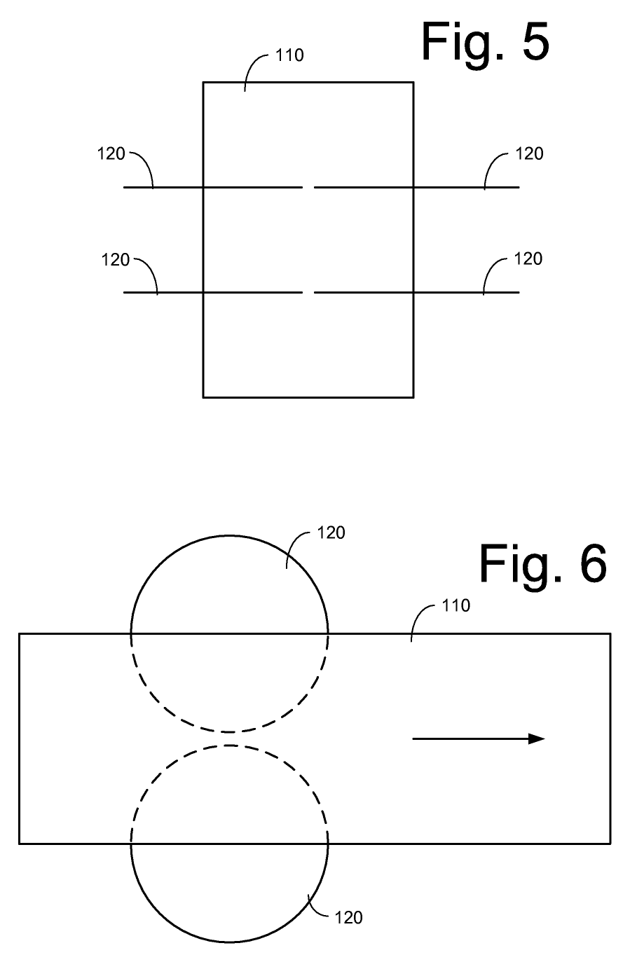

Wattle 100 may be formed from a conventional hay bale 110 (FIGS. 5-10). Conventional hay bales have dimensions of approximately 16 inches wide, 24 inches high and 48 inches long. It is understood that the dimensions of a hay bale 110 from which wattle 100 may be formed may vary from those set forth above in alternative embodiments.

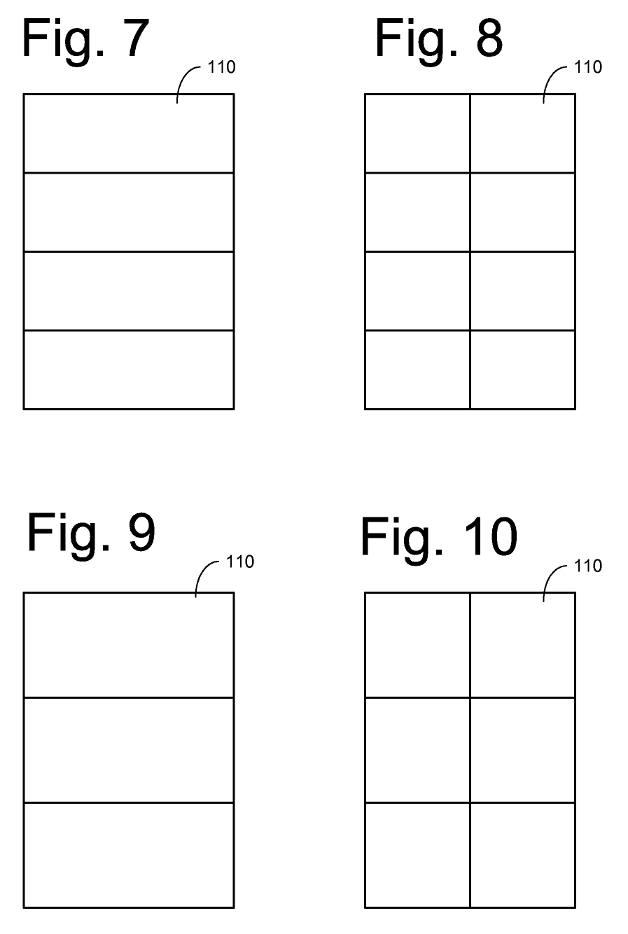

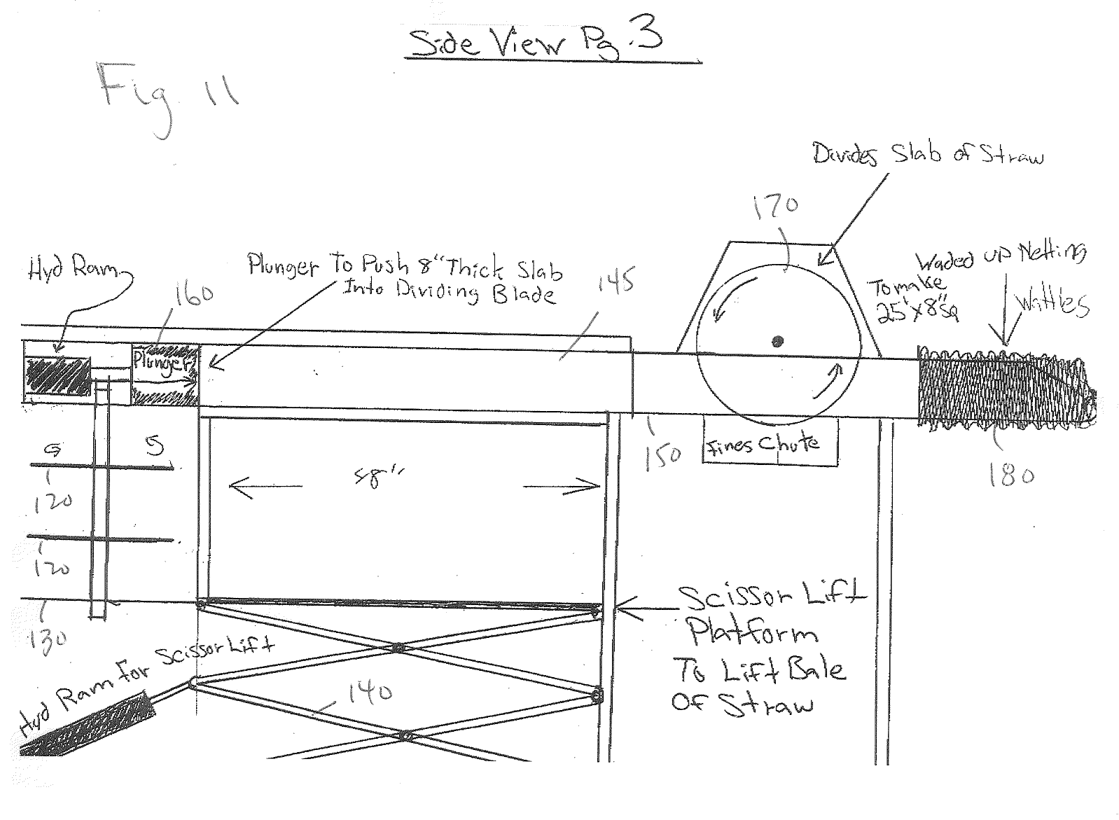

Hay bales 110 are sawed into wattles 100. Sawing the hay into wattles, instead of first pulverizing the hay and then forcing it into the netting, allows the wattles to have a predetermined cross-sectional shape. The bales 110 may be sawed into a variety of sizes and shapes. For example, a 16×24 square inch bale may be sawed into four sections of 16×6 (FIG. 7), eight sections of 8×6 (FIG. 8), three sections of 16×8 (FIG. 9) and six sections of 8×8 (FIG. 10), each with a length of 48 inches long. Other dimensions are possible.

An apparatus and process for forming the wattles of these and other dimensions is disclosed in FIGS. 5-6 and 11-20. A hay bale 110 is moved along a conveyor 130. In an embodiment including three or six sections, two sets of saws 120 oriented parallel to a plane including the length and width of the hay bale saw the hay bales into three sections. It is understood that instead of a cut being made by a set of two saws, a cut may be made by a single saw.

Once the sections are cut, a scissor lift 140 then lifts each of the cut sections upward successively. Once a section reaches a conveyor 145 at elevation 150, it is pushed forward by a plunger 160. Thus, where hay bale 110 is cut into three sections, the first section is raised upward until it reaches conveyor 145 at elevation 150, where plunger 160 pushes the first section forward; the second section is raised until it reaches elevation 150, where plunger 160 pushes the second section forward; and the third section is raised until it reaches elevation 150, where plunger 160 pushes the third section forward.

In embodiments, the hay bale may be further cut parallel to a plane including the height and length of the bale to form the original bale into six sections. In such embodiments, the plunger 160 pushes the sections forward to be cut by one or more saws 170 along a dimension substantially perpendicular to the first cuts. It is understood that the second cut need not be perpendicular to the first cuts and may be a variety of oblique angles.

In embodiments where the sections are cut by saw 170, the sections are then pushed into netting 180 which is bunched up on the ends of conveyor 145. Successive sections of cut bale are pushed into netting 180 to form wattles of any desired length. The wattle may be sealed at its front end by a tie 190. When a wattle is made to the desired length, it may be sealed at its rear end by a second tie 195.

Having one or more flat edges, the wattle may lie flat against the ground. Thus, the wattle does not roll or otherwise move, even when positioned on a slope. Moreover, having a flat surface in contact with the ground, a lot more of the wattle lies in contact with the ground in comparison to a conventional cylindrical wattle. Moreover, conventional wattles collapse relatively quickly because the hay fibers have no uniform orientation within the wattle and therefore impart relatively poor strength to the wattles. However, in the present invention, the hay may align in a uniform orientation, thereby imparting superior strength and longevity to the wattles according to the present invention.

While wattles 100 may be formed from hay, for example, rice hay, it is understood that other vegetation and materials may be used to form wattles 100 in alternative embodiments.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A method of forming a wattle, comprising the steps of:
(a) sawing a hay bale into a plurality of sections having one or more straight edges; and
(b) stuffing the plurality of sections into an outer layer.

2. A method as recited in claim 1, wherein said step (a) comprises the step of sawing the hay bale into a plurality of wattles having a substantially square cross-section.

3. A method as recited in claim 1, wherein said step (a) comprises the step of sawing the hay bale into a plurality of wattles having a substantially rectangular cross-section.

4. A method as recited in claim 1, wherein the hay bale has a width of 24 inches and a height of 16 inches, and wherein said step (a) comprises the step of sawing the hay bale into four sections having a 16×6 square inch cross-section.

5. A method as recited in claim 1, wherein the hay bale has a width of 24 inches and a height of 16 inches, and wherein said step (a) comprises the step of sawing the hay bale into eight sections having an 8×6 square inch cross-section.

6. A method as recited in claim 1, wherein the hay bale has a width of 24 inches and a height of 16 inches, and wherein said step (a) comprises the step of sawing the hay bale into three sections having a 16×8 square inch cross-section.

7. A method as recited in claim 1, wherein the hay bale has a width of 24 inches and a height of 16 inches, and wherein said step (a) comprises the step of sawing the hay bale into six sections having a 8×6 square inch cross-section.

8. A method as recited in claim 1, wherein said step (a) comprises the step of sawing through a first the hay bale along a first plane, and sawing through the hay bale along a second plane orthogonal to the first plane.

9. An apparatus for forming a wattle, comprising:
a set of one or more saw blades for sawing a hay bale into a plurality of sections;
netting for receiving the plurality of sections; and
a conveyor for conveying the hay bale through the set of one or more saw blades and into the netting.

10. An apparatus as recited in claim 9 wherein the conveyor comprises a plunger for pushing the hay bale and/or plurality of sections through the set of one or more saw blades and into the netting.

11. An apparatus as recited in claim 9 wherein the set of one or more saw blades comprises a first set of one or more saw blades for sawing in a first plane and a second set of one or more saw blades for sawing in a second plane orthogonal to the first plane.

12. A wattle formed of hay encased within an outer layer, the wattle comprising:
a first end;
a second end;
a length between the first and second ends; and
one or more substantially straight edges along the length of the wattle.

13. A wattle as recited in claim 12, the wattle formed by the step of sawing a hay bale to define the one or more substantially straight edges along the length of the wattle.

14. A wattle as recited in claim 12, the one or more straight edges comprising a first pair of opposed, substantially straight edges and a second pair of opposed, substantially straight edges substantially orthogonal to the first pair of opposed, substantially straight edges.

15. A wattle as recited in claim 12, the wattle having a substantially square cross section in a plane substantially perpendicular to the length.

16. A wattle as recited in claim 12, the wattle having a substantially rectangular cross section in a plane substantially perpendicular to the length.
